(19) United States
(12) Patent Application Publication
(10) Pub. No.: US 2025/0259638 A1
(43) Pub. Date: Aug. 14, 2025

(54) DIRECTIONAL ACTIVITY MASK DETECTOR FOR A VEHICLE

(71) Applicant: GM Global Technology Operations LLC, Detroit, MI (US)

(72) Inventors: Nili Yaron, Tel Aviv (IL); Elior Hadad, Ness-Ziona (IL); Gaurav Talwar, Novi, MI (US)

(73) Assignee: GM Global Technology Operations LLC, Detroit, MI (US)

(21) Appl. No.: 18/438,480

(22) Filed: Feb. 11, 2024

(51) Int. Cl. G10L 21/0208; G10L 21/0216; G10L 25/84

(52) U.S. Cl. CPC G10L 21/0208; G10L 25/84; G10L 2021/02166

(57) ABSTRACT

A method for a directional activity mask detector for a vehicle includes generating a blocking matrix based on pre-recorded signals from a target zone, receiving, at a voice activity detector, audio frames from a microphone array, and applying the blocking matrix to one or more zones within a vehicle. The method also includes detecting signals from unblocked zones of the vehicle, determining an activity of a target signal based on the detected signals from the unblocked zones, and estimating, by a beamformer, a relative transfer function (RTF) vector based on the received audio frames and the determined activity of the target signal.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Speech enhancement is required for both virtual assistant and hands-free applications. The present disclosure relates generally to a directional activity mask detector based on algebraic blocking matrix for detecting a target speaker in a vehicle acoustic environment and ignoring directional interference.

A beamformer is commonly used for speech enhancement of a target signal using a microphone array according to its direction. The target direction is defined by a steering vector, estimated by Relative transfer function tracking (RTFT) according to a target speech activity tracking. Often, the activity of a target signal is unknown or estimated. If the RTFT is updated with the wrong direction it may result in self-cancellation. Further, imprecise target activity detection may contaminate the direction tracking and may result in leakage of interference into a target output signal. Thus, there is a need to improve the activity detection of the target speaker when analyzing audio signals within a vehicle.

The proposed mask is applied on the received audio signal to indicate the RTFT adaptation according to active time frequency bins related to the correct direction of the target speaker.

### SUMMARY

One aspect of the disclosure provides a computer-implemented method for a directional activity mask detector for a vehicle that, when executed by data processing hardware, causes the data processing hardware to perform operations that include generating a blocking matrix based on pre-recorded signals from a target zone, receiving, at a voice activity detector, audio frames from a microphone array, and applying the blocking matrix to one or more zones within a vehicle. The operations also include detecting signals from unblocked zones of the vehicle, determining an activity of a target signal based on the detected signals from the unblocked zones, and estimating, by a beamformer, a relative transfer function (RTF) vector based on the received audio frames and the determined activity of the target signal.

Implementations of the disclosure may include one or more of the following optional features. In some examples, the operations include defining a blocking area of the blocking matrix. Optionally, the operations include tracking a noise floor with an energy detector. In some implementations, the operations include generating an energy threshold by Monte Carlo simulation. In these implementations, the operations may also include identifying an optimal energy threshold based on the energy threshold generated by the Monte Carlo simulation. Here, the operations may further include tailoring the identified optimal energy threshold for an audio task. Optionally, generating the blocking matrix include recording clean signals from each zone. In some implementations, the operations further include enhancing the received audio frames by transforming the audio frames into a short-time Fourier transform (STFT) domain.

Another aspect of the disclosure provides a system for a directional activity mask detector for a vehicle that includes data processing hardware and memory hardware in communication with the data processing hardware. The memory hardware stores instructions that when executed by the data processing hardware cause the data processing hardware to perform operations that include generating a blocking matrix based on pre-recorded signals from a target zone, receiving, at a voice activity detector, audio frames from a microphone array, and applying the blocking matrix to one or more zones within a vehicle. The operations also include detecting signals from unblocked zones of the vehicle, determining an activity of a target signal based on the detected signals from the unblocked zones, and estimating, by a beamformer, an RTF vector based on the received audio frames and the determined activity of the target signal.

This aspect may include one or more of the following optional features. In some examples, the operations include defining a blocking area of the blocking matrix. Optionally, the operations include tracking a noise floor with an energy detector. In some implementations, the operations include generating an energy threshold by Monte Carlo simulation. In these implementations, the operations may also include identifying an optimal energy threshold based on the energy threshold generated by the Monte Carlo simulation. Here, the operations may further include tailoring the identified optimal energy threshold for an audio task. Optionally, generating the blocking matrix include recording clean signals from each zone. In some implementations, the operations further include enhancing the received audio frames by transforming the audio frames into a short-time Fourier transform (STFT) domain.

Another aspect of the disclosure provides a system for a directional activity mask detector for a vehicle that includes data processing hardware and memory hardware in communication with the data processing hardware. The memory hardware stores instructions that when executed by the data processing hardware cause the data processing hardware to perform operations that include generating a blocking matrix based on a steering vector. Here, the blocking matrix includes a mask. The operations also include receiving, at a voice activity detector, audio frames from a microphone array, and applying the blocking matrix to one or more zones within the vehicle. The operations further include detecting signals from unblocked zones of the vehicle and determining an activity of a target signal based on the detected signals.

This aspect may include one or more of the following optional features. In some examples, the operations further include calculating a ratio of energy changes between a reference microphone signal and a maximum value of outputs of the blocking matrix. In these examples, the operations may further include generating the mask of the blocking matrix based on the ratio of energy changes. Here, the operations may also include identifying active bins of the mask and updating a relative transfer function (RTF) based on the identified active bins.

### BRIEF DESCRIPTION OF THE DRAWINGS

The drawings described herein are for illustrative purposes only of selected configurations and are not intended to limit the scope of the present disclosure.

FIG. 1 is a schematic of a vehicle equipped with a speech enhancement system according to the present disclosure;

FIG. 2 is a partial perspective view of an interior cabin of a vehicle with passengers emitting audio signals captured by a speech enhancement system according to the present disclosure;

FIG. 3 is a functional block diagram of a speech enhancement system according to the present disclosure;

FIG. 4 is a schematic of an interior of a vehicle according to the present disclosure with defined zones;

FIG. 5 is an example schematic of a speech enhancement system according to the present disclosure;

FIG. 6 is another example schematic of a speech enhancement system according to the present disclosure;

FIG. 7 is an example flow diagram for a speech enhancement system according to the present disclosure; and

FIG. 8 is a continued example flow diagram for the speech enhancement system of FIG. 7.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

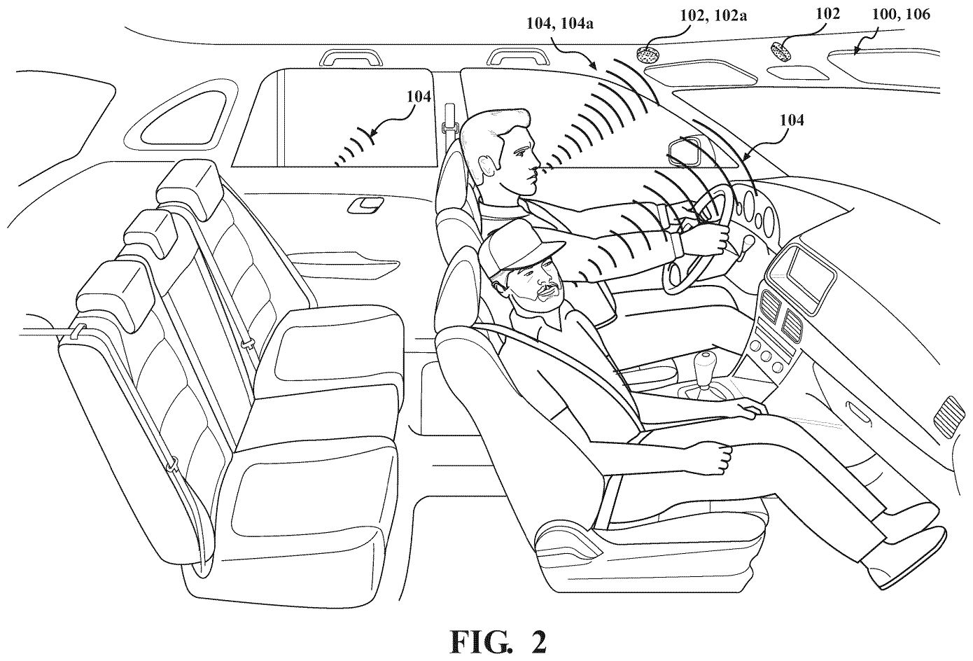

Referring now to the Figures, a speech enhancement system 10 is described with respect to a vehicle 100 equipped with a microphone array 102 configured to receive audio signals 104. With reference to FIG. 2, an interior cabin 106 of the vehicle 100 is illustrated with a driver and a passenger. The driver is illustrated as emitting an audio signal 104, which is captured by the microphone array 102. However, the passenger or passengers may also emit the audio signals 104. Further, the audio signals 104 may include environmental noise. The microphone array 102 includes a reference microphone 102a, which may be selected during a tuning process, described herein. It is contemplated that the speech enhancement system 10 may alter which microphone of the microphone array 102 may serve as the reference microphone 102a. Thus, the reference microphone 102a is selected according to the configuration of the microphone array 102 during a tuning process, as described in more detail below.

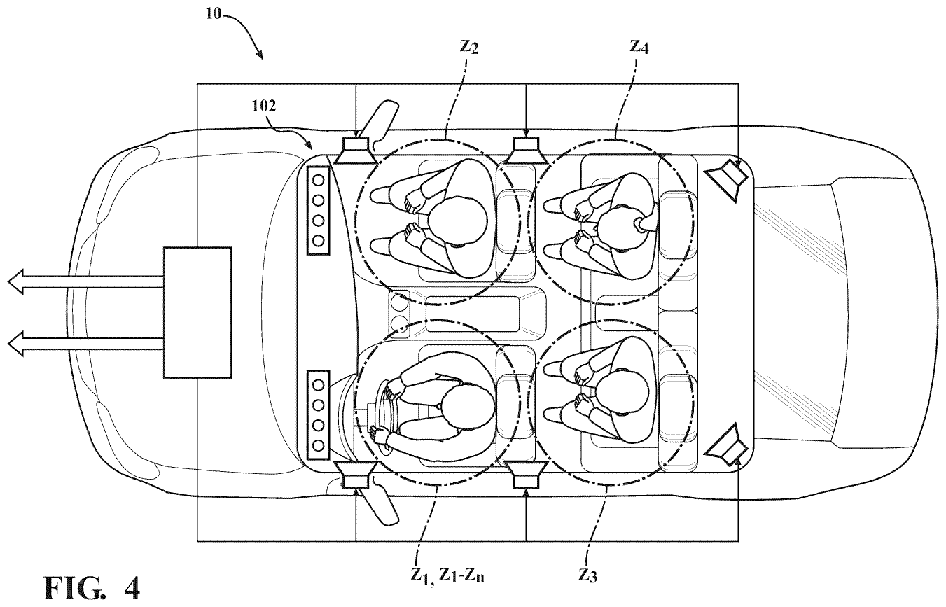

The vehicle 100 may be divided into a plurality of zones Z₁-Zₙ. For example, FIG. 4 illustrates the vehicle 100 as being divided into four zones Z₁-Z₄. It is contemplated that the speech enhancement system 10 may be configured to divide the vehicle 100 into fewer than four zones or greater than four zones depending on the size of the vehicle 100 and analysis performed by the speech enhancement system 10. The speech enhancement system 10 includes an electronic control unit (ECU) 12 of the vehicle 100 that is configured with a directional activity application 14. The directional activity application 14 is executed by data processing hardware 16 of the ECU 12. The ECU 12 may also include memory hardware 18 in communication with the data processing hardware 16. The memory hardware 18 stores operative functions of the directional activity application 14, described in more detail below.

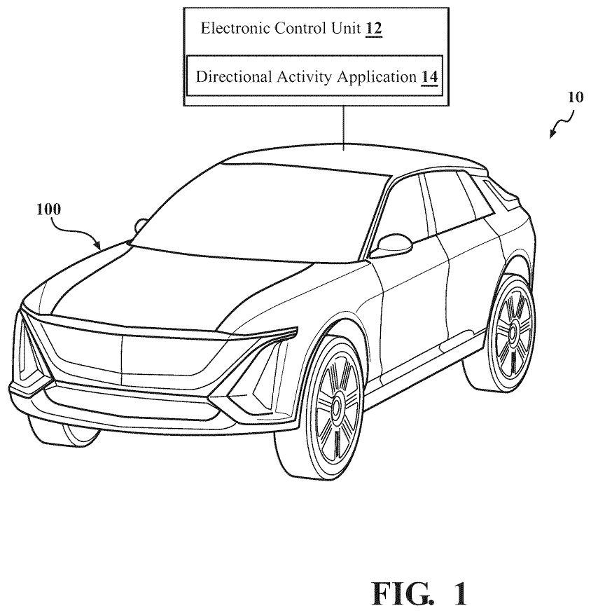

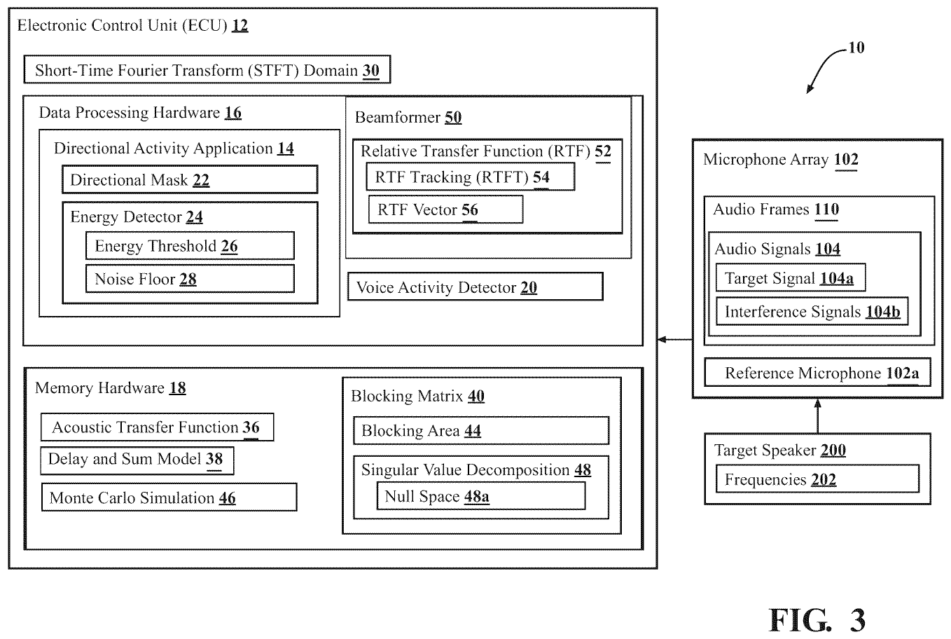

With further reference to FIGS. 1-4, the directional activity application 14 includes a voice activity detector 20 that is utilized in generating a directional mask 22 in combination with an energy detector 24. The energy detector 24 is configured with an energy threshold 26 and a noise floor 28. The energy threshold 26 and the noise floor 28 may vary depending on the desired output from the speech enhancement system 10. The audio signals 104 are received by the ECU 12 as audio frames 110. The audio frames 110 are in a time domain when received by the microphone array 102 and are converted into a frequency domain via a short-time Fourier transform (STFT) domain 30. The conversion into the STFT domain 30 may be executed by the data processing hardware 16 of the ECU 12. The directional activity application 14 receives the audio signals 104 as the converted frames 110 in real time. The memory hardware 18 may store an acoustic transfer function 36, a delay and sum model 38, and a blocking matrix 40, described in more detail below.

The directional activity application 14 utilizes the blocking matrix 40 in combination with the voice activity detector 20 and the energy detector 24 to generate the directional mask 22. Thus, the directional mask 22 may be based on the blocking matrix 40. For example, the blocking matrix 40 is designed to block a desired direction (e.g., a first zone Z₁ with the driver) and capture the remaining audio signals 104 from the remaining zones Z₂-Z₄ and compare the audio signals 104 to the reference microphone 102a. The audio signals 104 from the desired direction may be referred to herein as a target signal 104a or target signals 104a, and the remaining audio signals 104 may be referred to as an interference signal 104b or interference signals 104b.

The blocking matrix 40 is generated based on pre-recorded signals from an identified target zone. For example, the target signal(s) 104a are recorded during an offline tuning process and may be utilized to develop the blocking matrix 40. Once the blocking matrix 40 is developed, the blocking matrix 40 may be stored in the memory hardware 18 for selective use by the directional activity application 14. The directional activity application 14 may project the frames 110 onto the generated blocking matrix 40.

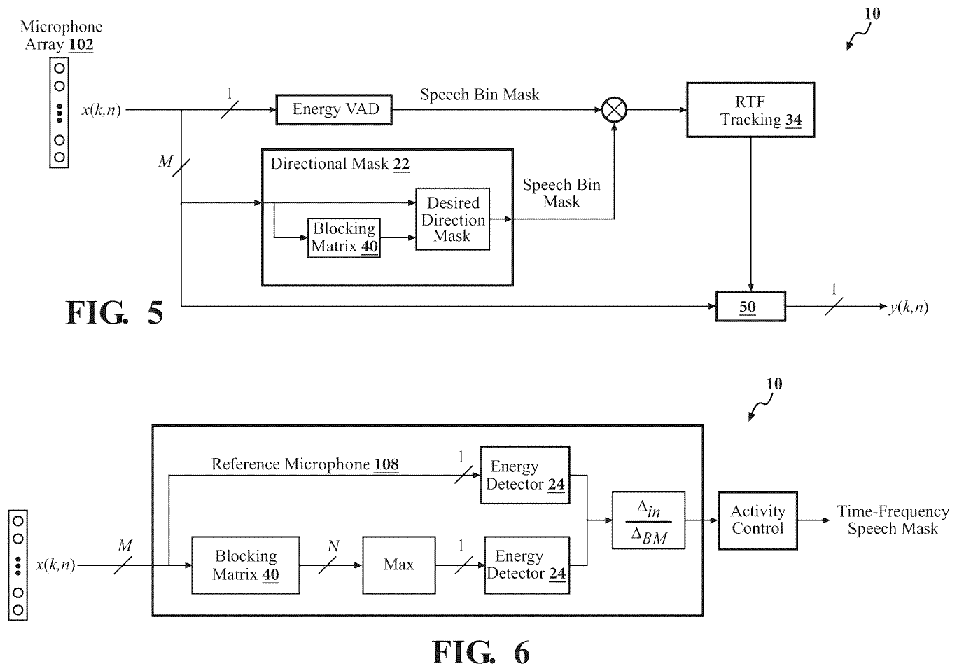

Referring to FIGS. 2-6, the ECU 12 receives the audio signals 104 from the microphone array 102 and may execute a beamformer 50 to enhance the target signal 104a. The beamformer 50 utilizes a relative transfer function (RTF) 52, which is determined by RTF tracking 54 to identify a steering or RTF vector 56 defined between the microphone array 102 and the target speaker 200 (e.g., the driver) to enhance the received target signals 104a. For example, the ECU 12 may determine the steering vector 56 based on the received signals 104.

In some examples, the voice activity detector 20 may be utilized to detect the target signal 104a based on energy, and the directional activity application 14 may supply the directional mask 22 to the RTFT 54 to estimate the RTF 52 on the target signal 104a. For example, the voice activity detector 20 receives frames 110 including the target signal 104a from the microphone array 102. The directional mask 22 may identify, from the audio signals 104, the target signal 104a according to the direction of each of the audio signals. Thus, the directional mask 22 provides a time frequency mask of the target signal 104a.

Each audio signal 104 includes a frame 110 that is converted into the time frequency domain to determine which frequencies 202 of the audio signals 104 are dominated by the target speaker 200. Differentiating the frames 110 assists in distinguishing the target signals 104a from the interference signals 104b, which may include other speakers and/or noise within the vehicle 100. The directional activity application 14 distinguishes the frames 110 to determine the directivity of the audio signals 104 and identify the target signal(s) 104a. For example, the directional mask 22 checks the directivity for a frequency of each frequency in each frame 110 to determine whether the directivity is comparable to the target signal(s) 104a. Once the directional mask 22 has determined the directivity, the directional activity application 14 may execute the RTFT 34 for the audio signals 104.

As described above, the vehicle 100 may be divided into a plurality of zones Z₁-Z₄, of which a single target zone is identified. The directional activity application 14 determines which, if any, zones Z₁-Z₄ are active and, within the active zones Z₁-Z₄, which frequencies 202, if any, of the audio signals 104 are active. The directional activity application 14 makes this determination per frequency 202 and distinguishes between active and inactive audio signals 104. For example, when a person is speaking within a target zone Z₁-Zₙ there may be other speakers within the zone Z₁-Zₙ that may register as inactive frequencies for the directional mask of that target zone Z₁-Zₙ. The directional mask 22 is utilized to create a timestamp of the frame 110 where there is activity to determine which audio signals 104 are active and which are not.

In some examples, some of the audio signals 104 may be from a driver, in a first zone Z₁ and some of the audio signals 104 may be from a passenger, in a second zone Z₂. The directional activity application 14 is configured to mask, via the directional mask 22, and separate the two sets of audio signals 104 to identify which frequencies 202 of the audio signals 104 are the target signal(s) 104a. The directional activity application 14 is configured to identify the directivity of the target signal(s) 104a and mask, or cover, the target position to check the energy to determine the coverage of the target position. If the directional activity application 14 detects signals 104 after covering or masking the target position, then the directional activity application 14 may determine that the detected, remaining signals 104 are interference signals 104b.

With further reference to FIGS. 2-6, the blocking matrix 40 is utilized to block the target zones Z₁-Zₙ, which may be utilized in building the beamformer 50. For example, the blocking matrix 40 is configured to block what is deemed to be the target zone Z₁-Zₙ, and the directional activity application 14 checks the output to determine whether signals 104 are still getting past the blocking matrix 40. In some examples, the blocking matrix 40 may be applied to one or more zones Z₁-Zₙ within the vehicle 100, and the directional activity application 14 may detect signals 104 from the unblocked zones to determine a directivity of the target signal 104a based on the detected signals 104 from the unblocked zones.

The results from the directional activity application 14 may be utilized in building and refining the beamformer 50. The blocking matrix 40 is developed, or built, to block the entire zone Z₁-Zₙ of the target speaker 200. The target speaker 200 is predefined depending on the task and may be positioned in different zones Z₁-Zₙ depending on the scenario during a tuning process of the system 10. For example, the directional activity application 14 may be dynamically adapted to assess the location of the target speaker 200 based on the activity of the target signals 104a. By assessing the outputs of the blocking matrix 40, in addition to the determined target position, the directional activity application 14 may more easily search for the target signal 104a.

In some examples, a single reference microphone 102a of the microphone array 102 is selected, and the energy detector 24 is applied to the reference microphone 102a. The energy detector 24 is configured to avoid the noise floor 28, such that the directionality is assessed when there is energy (e.g., a person speaking). For example, the directional activity application 14 may be configured to track the noise floor 28 within the energy detector 24. The noise floor 28 is configured to mitigate capturing non-energy based signals or environmental noise, such as road noise. Thus, the directional activity application 14 is configured to ignore environmental noise. The directional activity application 14 further assumes that there is a speaker, such that if there is energy within a zone Z₁-Zₙ and the zone Z₁-Zₙ is covered, then a change is detected. For example, the directional activity application 14 is searching for the change as a result of blocking or otherwise masking a zone Z₁-Zₙ.

For example, if a target speaker 200 is active (e.g., energy detected) and a change is detected in response to covering the zone Z₁-Zₙ, then the target speaker 200 is speaking within the covered zone Z₁-Zₙ regardless of position within the zone Z₁-Zₙ. Thus, the activity of the target signal 104a may be detected regardless of positioning of the target within zone Z₁-Zₙ.

During enhancement of the target signal 104a, the directional activity application 14 determines the energy per frequency compared to a previous frame 110 of the blocked zone Z₁-Zₙ. If there is no change of the energy per frequency at the compared frames 110, then the directional activity application 14 may determine that there are no searchable signals 104. As noted above, the directional activity application 14 will utilize a reference microphone 102a to search for the target signals 104a by comparing the received signals 104 from the reference microphone 102a to the blocking matrix 40 output. The reference microphone 102a is typically the closest microphone of the microphone array 102 to the target zone Z₁-Zₙ. For example, the directional activity application 14 may search for an active zone Z₁-Zₙ that contains several positions within the active zone Z₁-Zₙ. Thus, the directional activity application 14 may select as the reference microphone 102a the microphone closest to a target zone Z₁-Zₙ of the active zone Z₁-Zₙ. The reference microphone 102a is, thus, configured to be a predefined feature of the directional activity application 14, such that the reference microphone 102a can change depending on the zone Z₁-Zₙ relative to the orientation of the speaker. The reference microphone 102a is predefined during the tuning process based on the target zone Z₁-Zₙ, but may be altered during the tuning process to utilize a different microphone of the microphone array 102 as the reference microphone 102a.

Referring still to FIGS. 2-6, the directional activity application 14 utilizes the blocking matrix 40 to block the target signal 104a, and the energy detector 24 will detect a lowered energy. For example, the output of the blocking matrix 40 has N output channels, where the value of N is described in more detail below. The directional activity application 14 takes the maximum value of the N output channels and applies the energy detector 24 on the result. The outputs of the blocking matrix 40 may provide an indication as to whether a zone Z₁-Zₙ is active or inactive. If the outputs of the blocking matrix 40 include the target signal 104a, then the target signal 104a may be blocked by all of the blocking matrix 40 outputs. Thus, the maximum value of the blocking matrix channels 40 will not contain the target signal 104a. The directional activity application 14 calculates a ratio of energy changes between the received audio signals 104 and the received audio signals 104 after applying the blocking matrix 40. For example, the ratio of energy changes may be calculated between the reference microphone 102a signal and a maximum value of outputs of the blocking matrix 40. Further, the directional mask 22 may be generated based on the ratio of energy changes. When a target speaker 200 is active, the ratio will be higher than when there is no activity within a blocked zone Z₁-Zₙ.

FIG. 6 illustrates an example scenario where a target signal 104a is received by the reference microphone 102a and, on a lower branch, blocked by the blocking matrix 40. The target signal 104a, thus, passes through an upper branch of the directional activity application 14 through the reference microphone 102a and is processed by the energy detector 24 to generate a delta value (Δᵢₙ). The delta value generated along the upper branch is taken as a ratio with a delta value (Δ_{BM}) of the target signal 104a generated along the lower branch. The delta value from the lower branch of the directional activity application 14 is generated based on the energy detector 24 evaluating the signal 104a blocked by the blocking matrix. The energy detector 24 is applied on the maximum value of the P output channels of the blocking matrix. P is a parameter of the blocking matrix 40 that is less than M the number of microphones of the microphone array 102. When building the blocking matrix 40, the system 10 records several positions within the zones Z₁-Zₙ and uses the acoustic transfer function 36 to build the blocking matrix 40. Thus, the system 10 takes positions within the zones Z₁-Zₙ to build a zone direction.

In establishing the blocking matrix, the directional activity application 14 is tuned from each zone Z₁-Zₙ defined within the vehicle 100. The recordings from each zone Z₁-Zₙ are executed as clean recordings without noise to estimate an acoustic system of the vehicle 100. The representation of the target speaker 200 seating area may be estimated using the following exemplary equation (a):

$${x}_{l} ( k , n ) = {H}_{l} ( k ) s ( k , n ) \qquad ( a )$$

where xₗ(k, n) is the audio signals 104 and s(k, n) is a known target signal 104a, before propagating in the vehicle 100, and Hₗ(k) is the acoustic transfer function relating the microphones and the l-th seating position of the speaker. Hₗ(k) may be estimated using various models. For example, Hₗ(k) may be calculated based on a mathematical model 36 of the various zones Z₁-Zₙ and may be trained based on the signals s(k, n) and xₗ(k, n). The estimation may be dependent upon the construction and interior layout of the vehicle 100, so the approach of building the blocking matrix 40 may be geometric and tailored specifically to the vehicle 100.

In other examples, Hₗ(k) may be modeled using a delay and sum model 38, which assumes that Hₗ(k) only contains the delay from the direct path of the ATF 36, for each microphone in the microphone array 102, using the following exemplary equation (b):

$${H}_{l} ( k ) = {[ {e}^{j \frac{2 π k}{K} {τ}_{1 , l}} , {e}^{j \frac{2 π k}{K} {τ}_{2 , l}} , … , {e}^{j \frac{2 π k}{K} {τ}_{M , l}} ]}^{T} \qquad ( b )$$

Where τ_{m,l} is the time delay between m-the microphone in the microphone array 102 and the target speaker 200 in the l-th position. The delay represents the distance between the speaker and the microphone array 102. In some examples, the delay and sum model 38 may be advantageously utilized for vehicles 100 with a smaller interior cabin 106, whereas the estimation mentioned above may be advantageously utilized for vehicles with a larger interior cabin 106. It is contemplated that the ECU 12 is configured with both options, and the speech enhancement system 10 may determine the preferred option based on the configuration of the vehicle 100. All Hₗ(k) vectors define a direction of the target zone. The blocking matrix 40 may be built by concatenating Hₗ(k), which represents one position within the target zone, from all of the positions within the target zone Z₁-Zₙ. For example, the blocking matrix 40 may be built to block a direction of each column of A(k) in the following exemplary equation (c):

$$A ( k ) = [ \begin{matrix}{H}_{1} ( k ) & {H}_{2} ( k ) & … & {H}_{L} ( k )\end{matrix} ] \qquad ( c )$$

where L is the total number of positions that were recorded within the zones Z₁-Zₙ. If the number of positions, L, is larger than P, the L columns of matrix A(k) may be compressed to P columns, for the following null space extraction.

The blocking matrix 40 is designed to block the direction of the target signal 104a and can be constructed in a null space 48a. The null space 48a may be extracted by a singular value decomposition (SVD) 48 of columns of A(k)A(k)^{H} using the following exemplary equation (d):

$$A ( k ) {A ( k )}^{H} = U \sum {V}^{T} \qquad ( d )$$

where the blocking matrix 40 is represented by the null space of the space spanned by the columns A(k)A(k)^{H}, which represent the direction of the target signal 104a. The directional activity application may, thus, utilize SVD 48 for a signal null value 48a to obtain the composition of the columns. SVD 48 may be utilized by the directional activity application 14 as one example method of determining the directivity of the target signal(s) 104a. The columns of the blocking matrix 40 are the last N=M−P columns of V, which provide an orthonormal basis of null(A(k)A(k)H^{H}).

The energy detector 24 may then be applied to calculate the energy level for both the reference microphone 102a and the blocked target signal 104a, as generally described above with respect to FIG. 6. The energy detector 24 tracks the noise floor 28 to identify a high delta change. For example, the energy levels may be calculated using the following exemplary equations (e), (f):

$${Δ}_{i n} = {S}_{fast} \{ {Y}_{i n} \} - {S}_{slow} \{ {Y}_{i n} \} \qquad ( e )$$

$${Δ}_{B M} = {S}_{fast} \{ max ( {Y}_{B M} ) \} - {S}_{slow} \{ max ( {Y}_{B M} ) \} \qquad ( f )$$

where S is a smoothing operator.

The directional mask 22 is applied according to the following exemplary activity conditions (a)-(c):

$${Δ}_{i n} > EngTh \qquad ( a )$$

$${Δ}_{B M} < EngTh \qquad ( b )$$

$$\frac{{Δ}_{i n}}{{Δ}_{B M}} > EngRatioTh \qquad ( c )$$

The optimal energy threshold 26 is generated using a Monte Carlo simulation 46, such that the energy threshold 26 is defined per audio task. For example, the identified optimal energy threshold 26 may be tailored for an audio task. While described with respect to the Monte Carlo simulation 46, it is contemplated that other methods of identifying the energy threshold 26 may be utilized. For example, in some instances the speech enhancement system 10 may be configured to focus on refining precision and may, thus, maximize the ratio. In other instances the speech enhancement system 10 may be configured to focus on noise reduction and may, thus, minimize the false negative detections. Thus, the directional activity application 14, of the speech enhancement system 10, may execute a number of simulations for various energy thresholds 26 and determine which of the simulated energy thresholds 26 are optimal.

For example, an estimation of the steering vector 52 of the target signal 104a may be based on true/false bins that are predicted positive. The speech enhancement system 10 may identify active bins of the directional mask 22 and may update the RTF 32 based on the identified bins. In some examples, the requirement is to maximize the precision, defined as the following:

$$\frac{T P}{T P + F P}$$

For the task of noise reduction, the speech enhancement system 10 wants to avoid self-cancellation of the target signal 104a. Thus, the speech enhancement system may be configured to minimize the false negative scenarios. Depending on the task, the speech enhancement system 10 is configured to optimize the energy threshold 26 based on the task. For example, in some instances the speech enhancement of a specific zone Z₁-Zₙ, so the speech enhancement system 10 may only collect the audio signals 104 corresponding to that specific zone Z₁-Zₙ. Thus, the optimization criteria may change depending on the task. An exemplary block diagram of the true/false bins is outlined in Table 1 below:

TABLE 1
True/False Bins

| | Actual: Positive | Actual: Negative |
|---|---|---|
| Predicted: Positive | TP | FP |
| Predicted: Negative | FN | TN |

Where TP is a true positive, FP is a false positive, FN is a false negative, and TN is a true negative.

Although the speech enhancement system 10 is described herein with respect to focusing on a single zone Z₁-Zₙ, among the plurality of zones Z₁-Zₙ, it is contemplated that the processes described herein may be extended as a multivariate problem for multiple zones Z₁-Zₙ. Thus, the directional activity application 14 may be utilized and scaled for multiple zones Z₁-Zₙ within the vehicle 100, such that the entire speech enhancement system 10 is scalable. For example, the speech enhancement system 10 may apply the application 16 for each zone and compare the energy ratio of each of the zones Z₁-Zₙ with one another to identify the dominant zone Z₁-Zₙ.

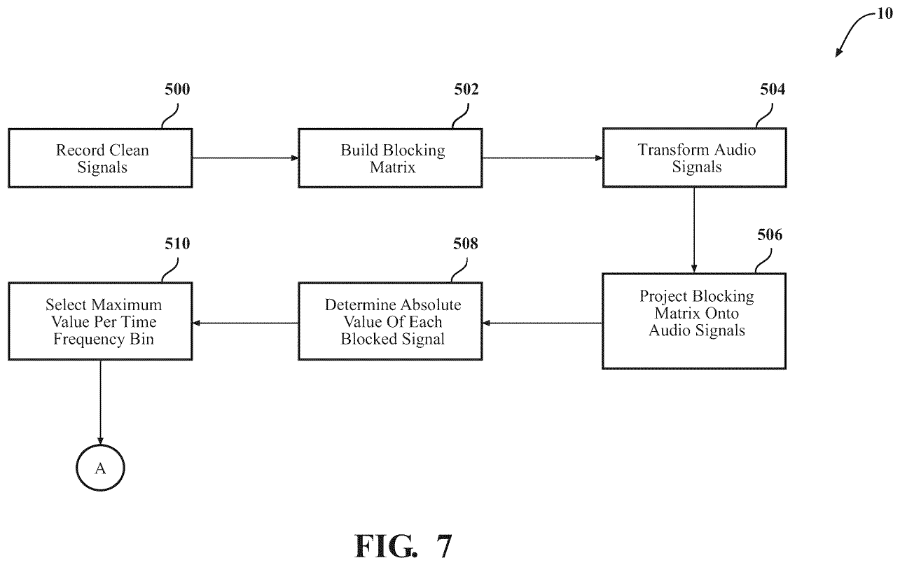

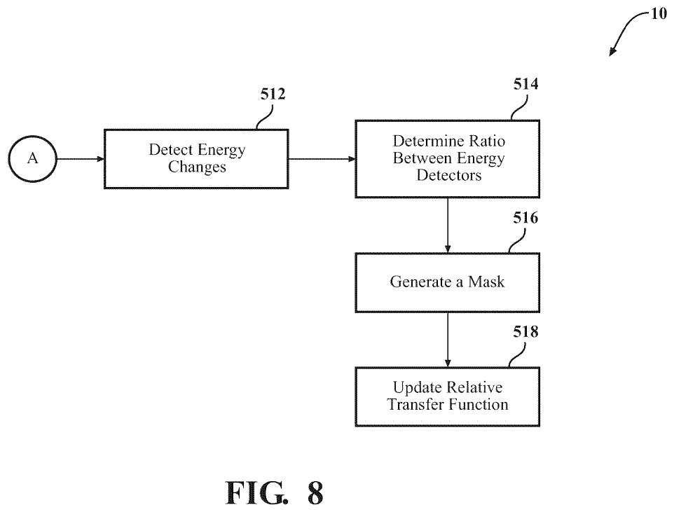

Referring to FIGS. 7 and 8, an exemplary flow diagram for the speech enhancement system 10 is depicted. At 500, the speech enhancement system 10 records clean audio signals 104. The speech enhancement system 10 may then build, at 502, the blocking matrix 40. The speech enhancement system 10 may then transform, at 504, the audio signals 104 and may project, at 506, the blocking matrix 40 onto the audio signals 104. The speech enhancement system 10 may then determine, at 508, an absolute value of each blocked audio signal 104 per time frequency bin, and may select, at 510, a maximum value per time frequency bin.

The speech enhancement system 10 may then detect, at 512, energy changes and may determine, at 514, a ratio between energy detectors 24. The speech enhancement system 10 generates, at 516, a directional mask 22. The speech enhancement system 10 may then update, at 518, the RTF 32.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
generating a blocking matrix based on pre-recorded signals from a target zone;
receiving, at a voice activity detector, audio frames from a microphone array;
applying the blocking matrix to one or more zones within a vehicle;
detecting signals from unblocked zones of the vehicle;
determining an activity of a target signal based on the detected signals from the unblocked zones;
estimating, by a beamformer, a relative transfer function (RTF) vector based on the received audio frames and the determined activity of the target signal.

2. The method of claim 1, wherein the operations further include defining a blocking area of the blocking matrix.

3. The method of claim 1, wherein the operations further include tracking a noise floor with an energy detector.

4. The method of claim 1, wherein the operations further include generating an energy threshold by Monte Carlo simulation.

5. The method of claim 4, wherein the operations further include identifying an optimal energy threshold based on the energy threshold generated by the Monte Carlo simulation.

6. The method of claim 5, wherein the operations further include tailoring the identified optimal energy threshold for an audio task.

7. The method of claim 1, wherein generating the blocking matrix includes recording clean signals from each zone.

8. The method of claim 1, wherein the operations further include enhancing the received audio frames by transforming the audio frames into a short-time Fourier transform (STFT) domain.

9. A speech enhancement system comprising:
data processing hardware; and
memory hardware in communication with the data processing hardware, the memory hardware storing instructions that when executed on the data processing hardware cause the data processing hardware to perform operations comprising:
generating a blocking matrix based on pre-recorded signals from a target zone;
receiving, at a voice activity detector, audio frames from a microphone array;
applying the blocking matrix to one or more zones within a vehicle;
detecting signals from unblocked zones of the vehicle;
determining an activity of a target signal based on the detected signals from the unblocked zones; and
estimating, by a beamformer, a relative transfer function (RTF) vector based on the received audio frames and the determined activity of the target signal.

10. The speech enhancement system of claim 9, wherein the operations further include defining a blocking area of the blocking matrix.

11. The speech enhancement system of claim 9, wherein the operations further include tracking a noise floor with an energy detector.

12. The speech enhancement system of claim 9, wherein the operations further include generating an energy threshold by Monte Carlo simulation.

13. The speech enhancement system of claim 12, wherein the operations further include identifying an optimal energy threshold based on the energy threshold generated by the Monte Carlo simulation.

14. The speech enhancement system of claim 13, wherein the operations further include tailoring the identified optimal energy threshold for an audio task.

15. The speech enhancement system of claim 9, wherein generating the blocking matrix includes recording clean signals from each zone.

16. The speech enhancement system of claim 9, wherein the operations further include enhancing the received audio frames by transforming the audio frames into a short-time Fourier transform (STFT) domain.

17. A speech enhancement system for a vehicle, the speech enhancement system comprising:
data processing hardware; and
memory hardware in communication with the data processing hardware, the memory hardware storing instructions that when executed on the data processing hardware cause the data processing hardware to perform operations comprising:
generating a blocking matrix based on a steering vector, the blocking matrix including a mask;
receiving, at a voice activity detector, audio frames from a microphone array;
applying the blocking matrix to one or more zones within the vehicle;
detecting signals from unblocked zones of the vehicle; and
determining an activity of a target signal based on the detected signals.

18. The speech enhancement system of claim 17, wherein the operations further include calculating a ratio of energy changes between a reference microphone signal and a maximum value of outputs of the blocking matrix.

19. The speech enhancement system of claim 18, wherein the operations further include generating the mask of the blocking matrix based on the ratio of energy changes.

20. The speech enhancement system of claim 19, wherein the operations further include identifying active bins of the mask and updating a relative transfer function (RTF) based on the identified active bins.
